(19) United States
(12) Patent Application Publication
(10) Pub. No.: US 2024/0177631 A1
(43) Pub. Date: May 30, 2024

(54) Emergency C-Section Task Trainer

(71) Applicant: Drexel University, Philadelphia, PA (US)

(72) Inventors: Shaila Quazi, Phoenixville, PA (US); Benjamin John Malinowski, Ephtrata, PA (US)

(21) Appl. No.: 18/521,388

(22) Filed: Nov. 28, 2023

Related U.S. Application Data
(60) Provisional application No. 63/428,864, filed on Nov. 30, 2022.

(51) Int. Cl. G09B 23/30; G09B 23/34

(52) U.S. Cl. CPC G09B 23/303; G09B 23/34

(57) ABSTRACT

An emergency C-Section task trainer includes a rigid frame, a simulated torso having an abdomen area mounted within the frame, and a simulated uterus in the torso below the abdomen area. A simulated fetus is located in the uterus. A plurality of first fluid conduits extends across the abdomen area and a plurality of second fluid conduits extends across the uterus.

### BACKGROUND OF THE INVENTION

### Field of the Invention

The invention relates to a training device for Caesarian section (C-section) deliveries.

### Description of the Related Art

Childbirth deliveries are typically performed by an obstetrician who is specifically trained and experienced in childbirth, whether by natural means, or by C-Section. In some circumstances, however, such as in an Emergency Room, an obstetrician may not be available and a baby must be delivered via C-section by an Emergency Room physician, who may not have never had to previously deliver a baby via C-Section.

It would be beneficial to provide a training device that can be used by non-obstetricians to practice performing C-sections.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention is an emergency C-Section task trainer that includes a rigid frame, a simulated torso having an abdomen area mounted within the frame, and a simulated uterus in the torso below the abdomen area. A simulated fetus is located in the uterus. A plurality of first fluid conduits extends across the abdomen area and a plurality of second fluid conduits extends across the uterus.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a side perspective view of an emergency C-Section Task trainer according to an exemplary embodiment of the present invention;

FIG. 2 is a front perspective view of the trainer of FIG. 1;

FIG. 3 is a front perspective view of a frame used in the trainer of FIG. 1;

FIG. 4 is a rear perspective of an abdomen area used in the trainer of FIG. 1;

FIG. 5 is a perspective view of the trainer of FIG. 1 with the abdomen area partially rolled away;

FIG. 6 is a rear perspective view of a uterus used in the trainer of FIG. 1; and

FIG. 7 is a perspective view of the trainer of FIG. 1 with the abdomen area and the uterus rolled away.

### DETAILED DESCRIPTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The word “about” is used herein to include a value of +/−10 percent of the numerical value modified by the word “about” and the word “generally” is used herein to mean “without regard to particulars or exceptions.”

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

C-Sections births are performed when a fetus cannot, for various reasons, be delivered vaginally. An attending physician, typically an obstetrician, makes an incision in the mother's abdominal wall to access the fetus for removal from the mother. Emergency C-Sections have to be occasionally performed in an emergency room setting by an emergency room physician when a pregnant patient presents in cardiac arrest. The present invention provides a training device for both obstetrical and emergent conditions. The device provides an abdominal wall, a uterus, and a placenta that a clinician must cut through in order to remove a simulated fetus.

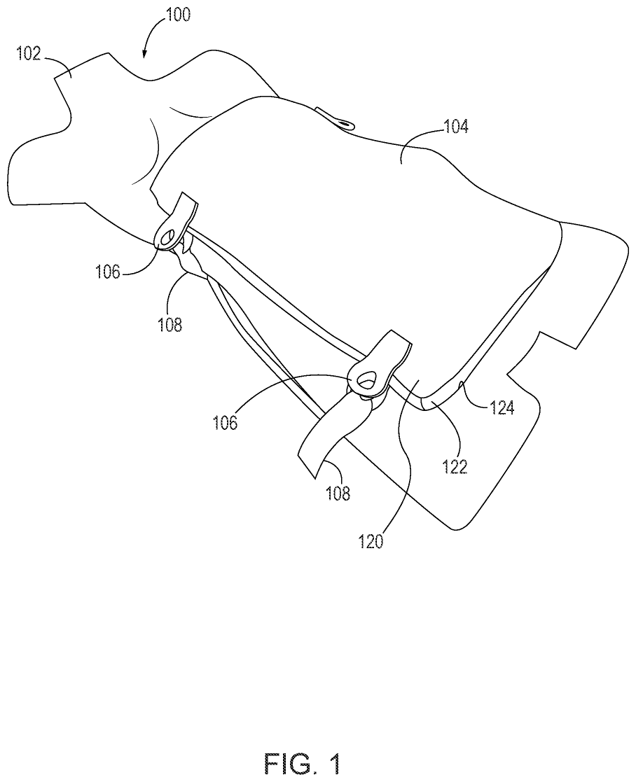

An emergency C-Section task trainer device 100 (“device 100”) according to an exemplary embodiment of the present invention is shown in FIG. 1. Device 100 includes a torso 102 with a simulated abdomen area 104 that is cut into by the clinician to access the fetus. Optionally, abdomen area 104 can be releasably affixed to the torso 102 by a plurality of clamps 106 on either side of abdomen area 104. Clamps 106 are connected to straps 108 that extend underneath torso 102 and connect to corresponding clamps 106 on a far side of torso 102. Clamps 106 can be removed to remove abdomen area 104 from torso 102.

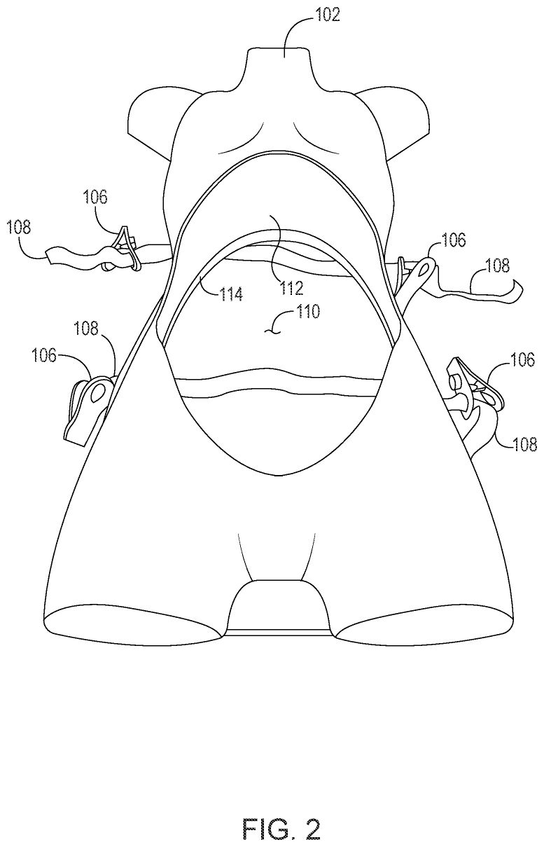

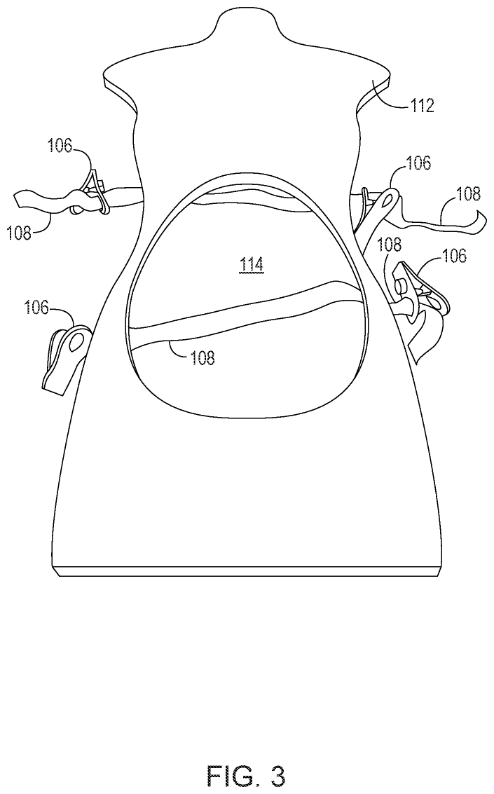

Referring to FIG. 2, torso 102 can be constructed from a rigid polymer, such as a polystyrene or other suitable polymer. A cavity 110 is formed in the middle of torso 102 to allow abdomen area (not shown in FIG. 2) to be removably inserted therein. Referring to FIGS. 2 and 3, a lower frame 112 with a cavity 114 corresponding to cavity 110 is formed in lower frame 112. Cavity 114 provides additional volume for the insertion of abdomen area 104.

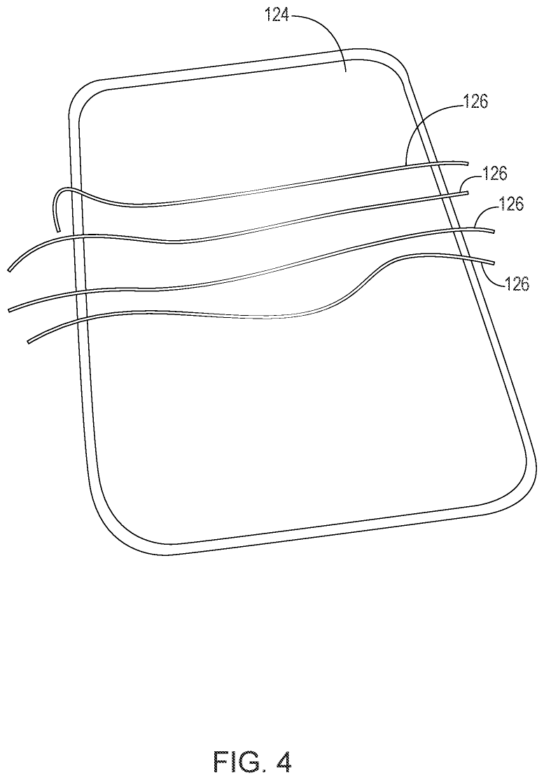

Referring back to FIG. 1, abdomen area 104 is constructed from three layers 120, 122, 124 of molded polymer material, such as silicone rubber manufactured by Smooth-On of Macungie, PA. These layers represent a layer 120 of skin, an underlayer 122 of fat, and a further under layer 124 of muscle that the clinician must cut through in order to access the uterus and then the fetus. While layer 124 of muscle is being formed, a plurality of fluid conduits 126 are inserted laterally across abdomen area 104 in layer 124 of muscle, as shown in FIG. 4. Fluid conduits 126 can be pressurized with a red liquid to simulate blood.

Optionally, although not shown, a mesh layer can be provided with each layer 120, 122, 124 to add drag and feel for the clinician when cutting through layers 120, 122, 124, as well as to help the suturing process after the simulated fetus is removed from device 100.

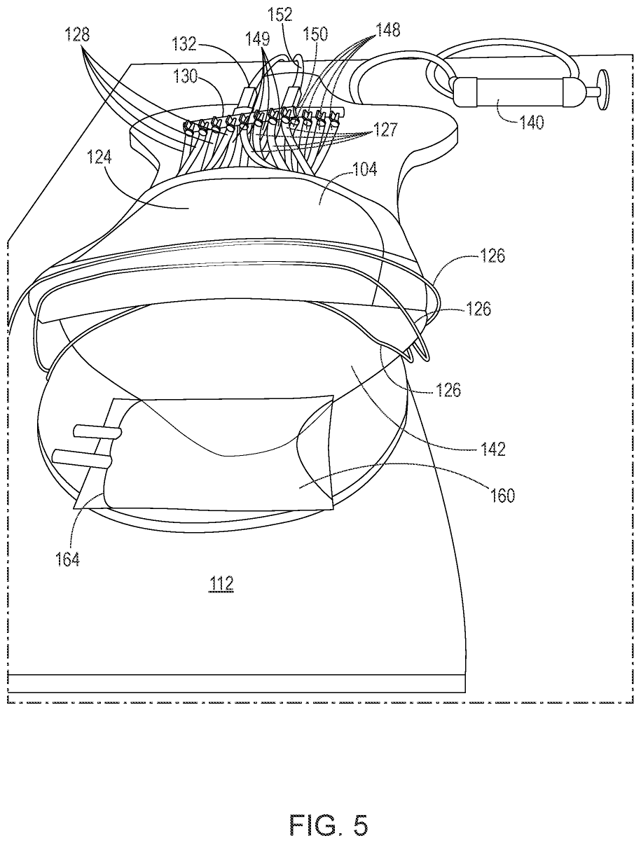

Referring to FIG. 5, ends 127, 128 of each fluid conduit 126 are connected to a first manifold 130 such that each fluid conduit 126 forms a closed loop with manifold 130. This feature can increase the pressure across each fluid conduit 126 to better simulate blood flow through the abdomen area 104. A first manifold supply connection 132 connects first manifold 130 to a fluid supply, not shown, that is provided via a pump 140.

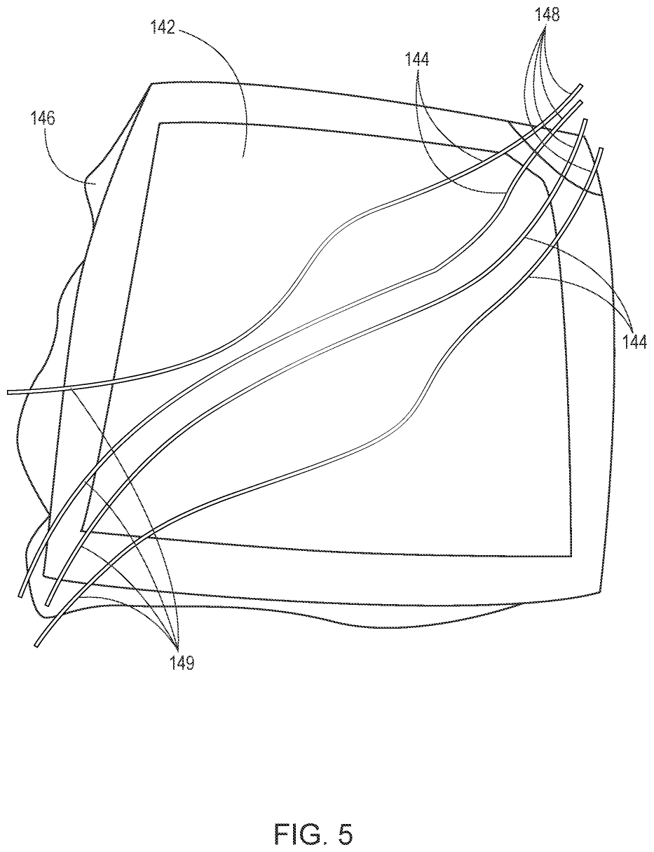

A simulated uterus 142 is provided below abdomen area 104. Similar to abdomen area 104, uterus 142 is constructed from a molded polymer material, such as silicon manufactured by Smooth-On of Macungie, PA. While uterus 142 is being formed, a plurality of fluid conduits 146 are inserted diagonally across uterus 142, as shown in FIG. 6. Fluid conduits 146 can be pressurized with a red liquid to simulate blood. Optionally, a mesh layer 146 can be provided with in uterus 142 to add drag and feel for the clinician when cutting through uterus 142, as well as to help the suturing process after the simulated fetus is removed from device 100.

Referring back to FIG. 5, uterus 142 is placed diagonally to simulate the shape of uterus 142 inside the body. Ends 148, 149 of each fluid conduit 144 are connected to a second manifold 150 such that each fluid conduit 144 forms a closed loop with manifold 1350. This feature can increase the pressure across each fluid conduit 144 to better simulate blood flow through the uterus 142. A second manifold supply connection 152 connects second manifold 150 to a fluid supply, not shown, that is provided via pump 140.

While two manifolds 130, 150 are shown and are both connected to pump 140, with eight fluid conduits 126, 144 extending from each respective manifold 130, 150, those skilled in the art will recognize that pressurized fluid can be delivered to both abdomen area 104 and uterus 142 using other known mechanisms.

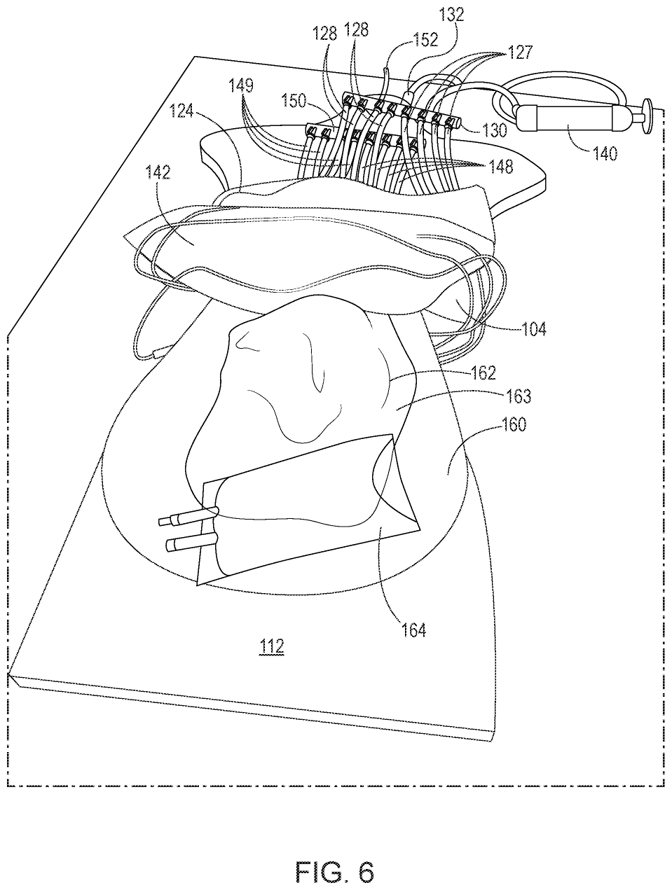

Referring now to FIG. 7, a basin 160 can be set at least partially into lower frame 112. Basin 160 can be used to support a simulated fetus 162 inside an umbilical sac 163, along with an intravenous (IV) bag 164 located below fetus 162. IV bag 164 simulates a location of a bladder. If, when the clinician is cutting uterus 142 to access fetus 162, the clinician cuts too far, IV bag 164 can be ruptured, dispensing IV fluid from IV bag 164, providing an indication that the clinician cut too far.

To use trainer 100, trainer 100 is placed upon a table as shown in FIG. 1. The clinician who will be training to deliver fetus 162 will be provided with the necessary tools, such as a scalpel, clamps, and other typical tools and devices used in a hospital emergency room setting. The clinician uses a scalpel to cut a vertical cut into abdomen area 104, cutting through layer 120 of skin, underlayer 122 of fat, and under layer 124 of muscle. In cutting through layers 120, 122, 124, the clinician will also cut through fluids conduit 126. Because pump 140 is pressurizing fluid in fluid conduit 126, the simulated blood will spurt from any severed fluid conduits 126.

Similarly, the clinician must cut through uterus 142 and fluid conduits 146. Because pump 140 is pressurizing fluid in fluid conduits 146, the simulated blood will spurt from any severed fluid conduit 146. After cutting trough uterus 142, the clinician cuts umbilical sac 163 and removes fetus 162.

After fetus 162 is removed, the clinician must then remove umbilical sac 163, medically treat any severed fluid conduits 126, 146, and close up uterus 142 and abdomen area 104.

It is anticipated that device 100 can be used no more than 3-4 times before abdomen area 104 and uterus 142 must be replaced with a new abdomen area 104 and uterus 142 due to the number of slices formed in abdomen area 104 and uterus 142 and corresponding fluid conduits 126, 144.

It will be further understood that various changes in the details, materials, and arrangements of the parts which have been described and illustrated in order to explain the nature of this invention may be made by those skilled in the art without departing from the scope of the invention as expressed in the following claims.

We claim:

1. An emergency C-Section task trainer comprising:
a rigid frame;
a simulated torso having an abdomen area mounted within the frame;
a simulated uterus in the torso below the abdomen area;
a simulated fetus in the uterus;
a plurality of first fluid conduits extending across the abdomen area; and
a plurality of second fluid conduits extending across the uterus.

2. The emergency C-Section task trainer according to claim 1, wherein the frame has a cavity formed therein.

3. The emergency C-Section task trainer according to claim 2, wherein the torso is inserted into the cavity.

4. The emergency C-Section task trainer according to claim 1, wherein the abdomen area is constructed from a plurality of differing layers.

5. The emergency C-Section trainer according to claim 4, wherein the plurality of differing layers represent a layer of skin, an underlayer of fat, and a further under layer of muscle.

6. The emergency C-Section task trainer according to claim 5, wherein the plurality of fluid conduits extend through the further under layer.

7. The emergency C-Section task trainer according to claim 1, wherein the plurality of first fluid conduits extend laterally across the abdomen area.

8. The emergency C-Section task trainer according to claim 1, wherein each of the plurality of first fluid conduits has a first end connected to a first manifold and a second end also connected to the first manifold.

9. The emergency C-Section task trainer according to claim 8, further comprising a first fluid supply in fluid communication with the first manifold.

10. The emergency C-Section task trainer according to claim 9, further comprising a first pump in fluid communication with the first fluid supply.

11. The emergency C-Section task trainer according to claim 1, wherein each of the plurality of second fluid conduits has a first end connected to a second manifold and a second end also connected to the second manifold.

12. The emergency C-Section task trainer according to claim 11, further comprising a second fluid supply in fluid communication with the second manifold.

13. The emergency C-Section task trainer according to claim 12, further comprising a second pump in fluid communication with the second fluid supply.

14. The emergency C-Section task trainer according to claim 1, wherein the plurality of second fluid conduits extend diagonally across the uterus.

15. The emergency C-Section task trainer according to claim 1, wherein the abdomen area is releasably connected to the torso.

16. The emergency C-Section task trainer according to claim 1, wherein the torso is constructed from a rigid polymer.

17. The emergency C-Section task trainer according to claim 1, further comprising a basin located at least partially in the frame.

18. The emergency C-Section task trainer according to claim 1, further comprising a simulated umbilical sac, wherein the simulated fetus is inside the simulated umbilical sac.

19. The emergency C-Section task trainer according to claim 18, further comprising a fluid filled bag located below the fetus.

20. An emergency C-Section task trainer comprising:
a simulated torso having an abdomen area;
a plurality of first fluid conduits extending across the abdomen area;
a simulated uterus in the torso below the abdomen area;
a plurality of second fluid conduits extending across the uterus; and
a simulated fetus in the uterus.
